(19) United States
(12) Patent Application Publication
(10) Pub. No.: US 2021/0000293 A1
(43) Pub. Date: Jan. 7, 2021

(54) BARBEQUE GRILL THERMAL BARRIER APPARATUS

(71) Applicant: Dale Holtz, Abbotsford (CA)

(72) Inventor: Dale Holtz, Abbotsford (CA)

(21) Appl. No.: 16/503,524

(22) Filed: Jul. 4, 2019

(51) Int. Cl. A47J 37/07; F24C 15/34

(52) U.S. Cl. CPC A47J 37/0786; F24C 15/34

(57) ABSTRACT

A thermal barrier apparatus for use with the barbeque grill. The apparatus includes a thermal barrier structure constructed from heat resistant material and a securing structure secured to the thermal barrier structure and the barbeque grill. The thermal barrier structure is located at a distance sufficiently away from the barbeque grill such that the thermal barrier structure provides a thermal barrier for heat emitted from the barbeque grill while not impairing the operation of the barbeque grill.

### REFERENCE TO PENDING APPLICATIONS

This application does not claim the benefit of any issued U.S. patent or pending application.

### TECHNICAL FIELD

The present invention relates generally toward the management of generated heat from a barbeque grill, and specifically, toward a barbeque thermal barrier apparatus for the management of generated heat from a barbeque grill.

### BACKGROUND

A barbecue grill, hibachi or other similar cooking device cooks food by applying heat from an open flame. These devices are typically used outdoors on a patio or porch. The heat generated by these devices, however, is not limited to the device's cooking surface. This heat may affect, and cause damage to, the surrounding area, including building structural walls, furniture, etc. The extent of the heat damage includes thousands of residential home fires each year. Further, it is reported that thousands of people are treated annually for thermal burns relating to barbeque grills.

As such, there is a need for a device to address the above issues.

### SUMMARY

The present invention relates generally toward the management of generated heat from a barbeque grill, and specifically, toward a barbeque thermal barrier apparatus for the management of generated heat from a barbeque grill.

In one aspect, a thermal barrier apparatus for use with a barbeque grill is disclosed. The use of the term barbeque grill herein refers to any barbecue grill, hibachi, smoker or other similar cooking device that cooks food by applying heat from an open flame.

The apparatus includes a thermal barrier structure constructed from heat resistant material and a securing structure secured to the thermal barrier structure and the barbeque grill. The thermal barrier structure is located at a distance sufficiently away from the barbeque grill such that the thermal barrier structure provides a thermal barrier for heat emitted from the barbeque grill while not impairing the operation of the barbeque grill.

The dimensions of the thermal barrier structure may extend at least to the width, or beyond the width, of the barbeque grill. Further, the thermal barrier may extend above the height of the barbeque grill when the grill's lid is in the open position.

In one aspect of the securing structure, it may include at least two support arms where each support arm is secured to the barbeque grill and to the thermal barrier structure. The securing structure may be adaptable to accommodate barbeque grills having differing widths.

In one aspect of the thermal barrier structure, it may include a rotational mechanism to allow the thermal barrier structure to be rotated to a desired angle relative to the barbeque grill.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a side perspective view of an embodiment of the present invention.

FIG. 2 is a front perspective view of an embodiment of the present invention.

FIG. 3 is a side view of an embodiment of the present invention.

FIG. 4 is a front view of an embodiment of the thermal barrier structure of present invention.

FIG. 5 is a side view of an embodiment of the support arm portion of present invention.

FIG. 6 is a back view of an additional embodiment of the present invention illustrating a narrow connection between the thermal barrier structure and support structure.

FIG. 7 is a front view of an additional embodiment of the present invention illustrating a wide connection between the thermal barrier structure and support structure.

FIG. 8 is a front view of an additional embodiment of the present invention illustrating a narrow connection between the thermal barrier structure and support structure.

FIG. 9 is a front view of an embodiment of the support structure of present invention.

FIG. 10 is a back view of an additional embodiment of the thermal barrier structure of present invention.

FIG. 11 is a side view of the embodiment of the thermal barrier structure of present invention as illustrated in FIG. 7.

FIG. 12 is a side view of the embodiment of the of present invention as illustrated in FIG. 7.

FIG. 13 is a front view of an additional embodiment of the thermal barrier structure of present invention.

FIG. 14 is a side perspective view of an additional embodiment of the present invention.

FIG. 15 is a perspective side view of an additional embodiment of the support arm portion of present invention.

FIG. 16 is a perspective side view of an additional embodiment of the support arm portion of present invention.

### DETAILED DESCRIPTION OF THE INVENTION

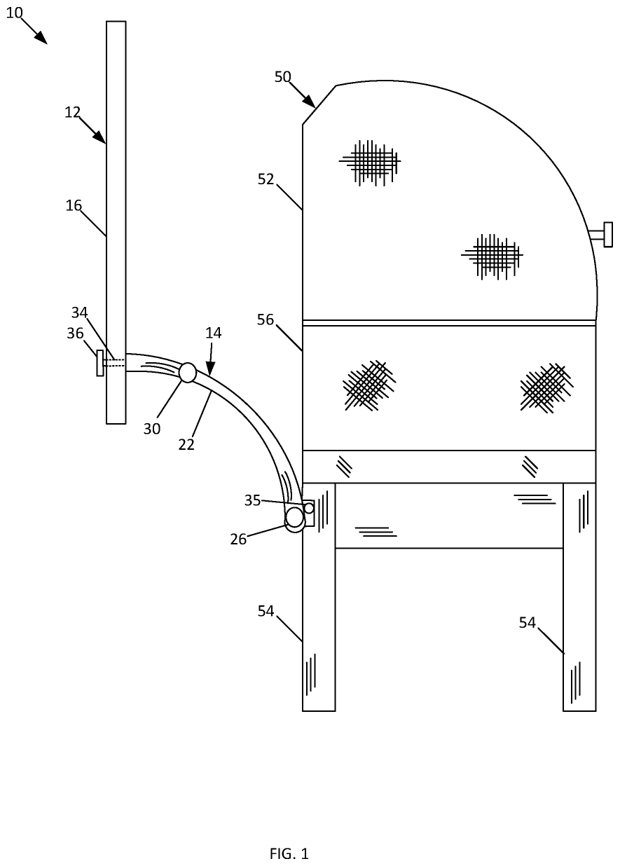

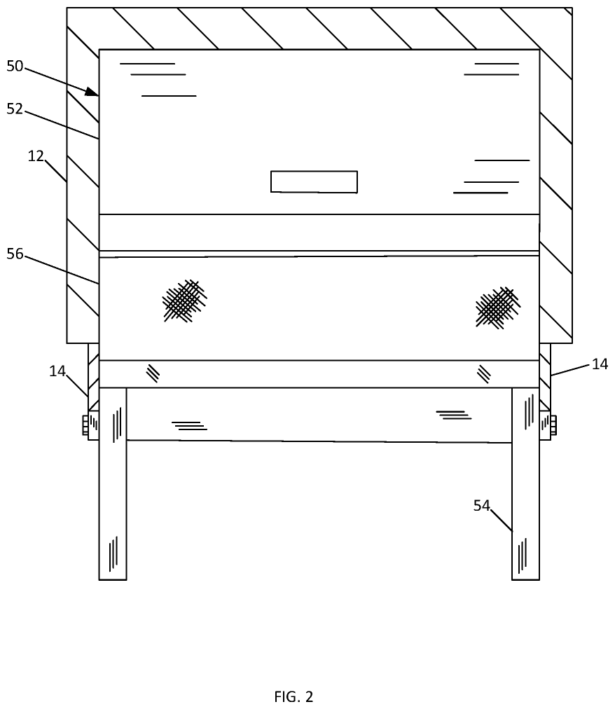

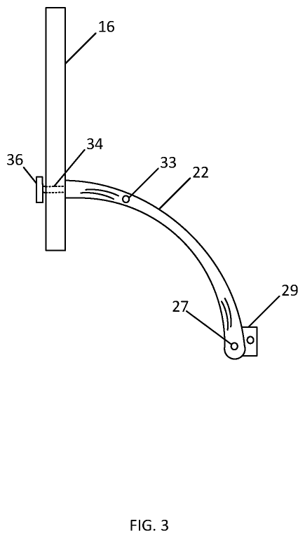

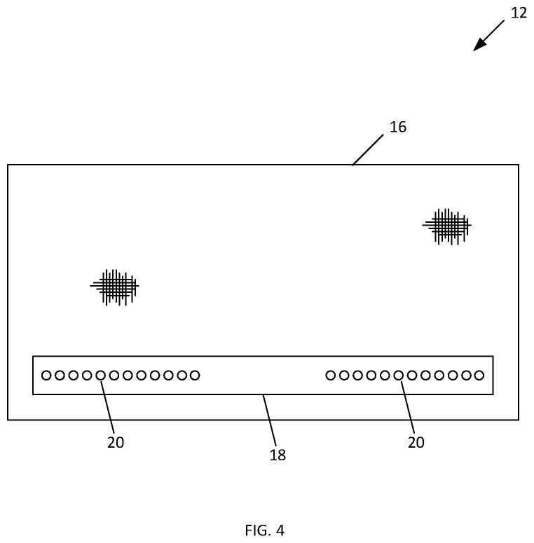

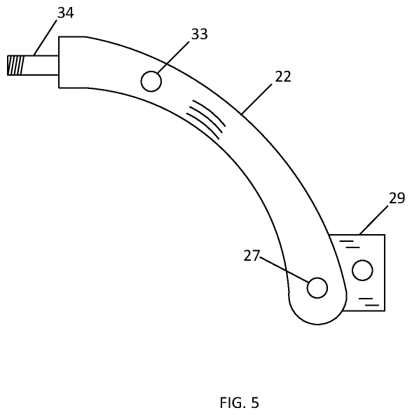

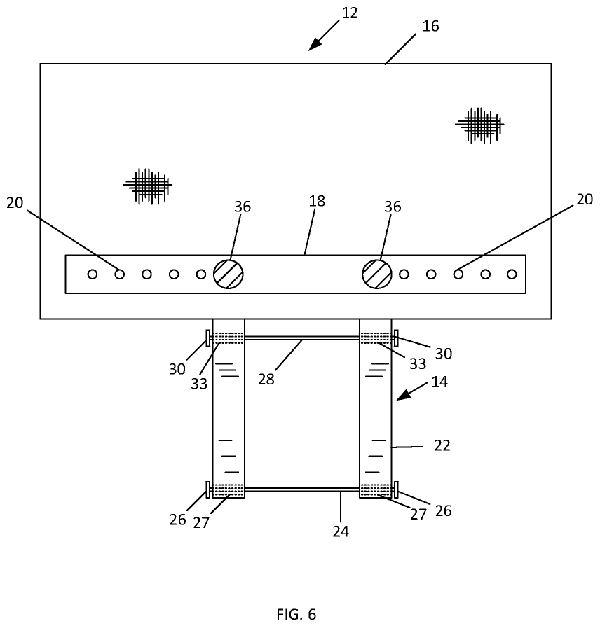

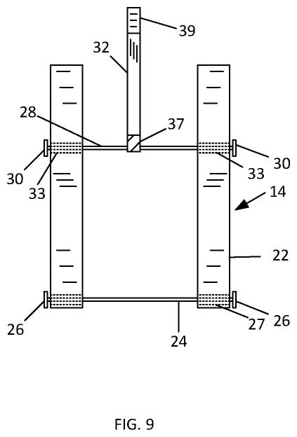

As illustrated in FIGS. 1-9, an embodiment of a thermal barrier apparatus 10 is disclosed. Thermal barrier apparatus 10 is generally secured to a barbecue grill 50 having a grill section 56 being supported by a plurality of legs 54 and a lid 52. Thermal barrier 10 is positioned at a distance away from barbecue grill 50 so as not to interfere with the normal course of operation of barbecue grill 50 but close enough to act as a thermal barrier to reduce the amount of heat that is exposed to a wall or other structures located behind the grill.

Thermal barrier apparatus 10 includes a thermal barrier structure 12 and a securing structure 14. Thermal barrier structure 12 is constructed from heat resistant material which is capable of absorbing heat emitted from barbecue grill 50. Securing structure 14 secures thermal barrier structure 12 to barbecue grill 50.

The width of thermal barrier structure 12 may extend at least as wide or wider than as barbecue grill 50. Further, the height of thermal barrier structure 12 may extend above the height of barbecue grill 50 when lid 52 is in an open position. This allows thermal barrier structure 12 to act as a heat shield to prevent heat being generated by barbecue grill 50 from adversely affecting any structure or other item.

In this embodiment, support structure for 14 may include two support arms 22 secured to thermal barrier structure 12 and secured to legs 54. Each support arm 22 has a flange 29 that attaches to leg 54 and secured thereto by leg securing bolt 35.

Additional lateral support may be provided by a lower support rod 24 and an upper support rod 28 being secured to support arm 22 by a lower rod adjustment knob 26 and an upper rod adjustment knob 30 respectively. Lower support rod 24 passes through lower access opening 27 of support arm 22 and secured thereto by lower arm securing knob 26. Upper support rod 28 passes through upper access opening 33 of support arm 22 and is secured thereto by upper arm securing knob 30. While this embodiment secures various securing knobs as a fastener, such is illustrative and not meant to be limiting. Those skilled in the art will recognize that any suitable fastener, such as but not limited to screws, bolts, magnets, etc., may be utilized and is within the scope of the present invention.

Moreover, additional support may be provided by center support bracket 32 that may be connected between upper support rod 28 and to barbecue grill 50. In this embodiment, a first end 37 of center support bracket engages upper support arm 28 while a second end 39 is attached to grill 50. This will cause center support bracket 32 to provide tension-based support to apparatus 10.

Thermal barrier structure 12 may include a heatshield 16 and a support plate 18 having a plurality of support access openings 20. Support access openings 20 are configured to receive one end of support arm 22. In this embodiment support arm 22 includes an attaching bolt 34 which mates with one of the support access openings 20 whereby a support plate adjustment knob 36 secures support arm 22 to support plate 18.

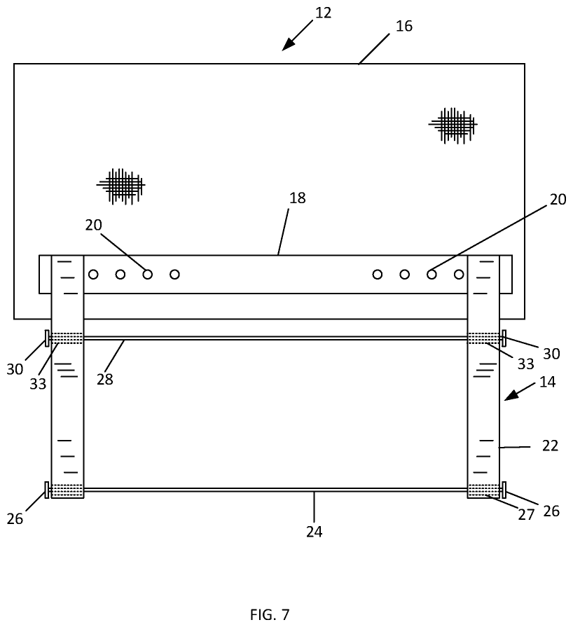

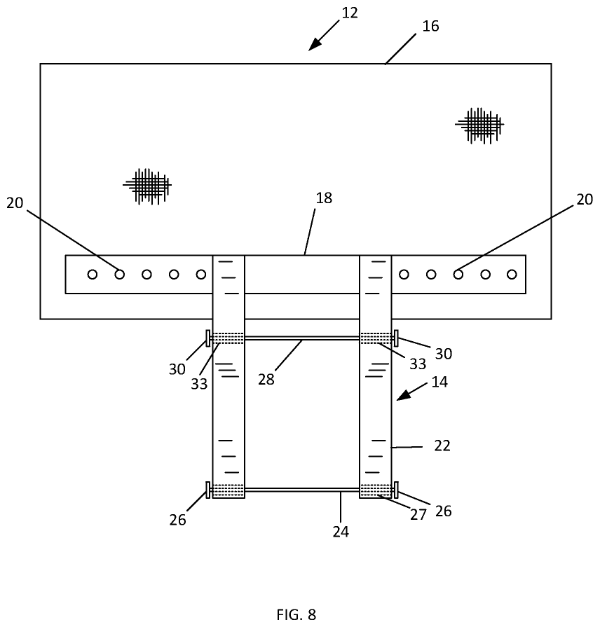

As best illustrated in FIGS. 7 and 8, support plate 18 may include a plurality of support access openings 20 running horizontally there along. This will allow for support structure 14 to be configured to be adaptable to a plurality of barbecue grills having different widths.

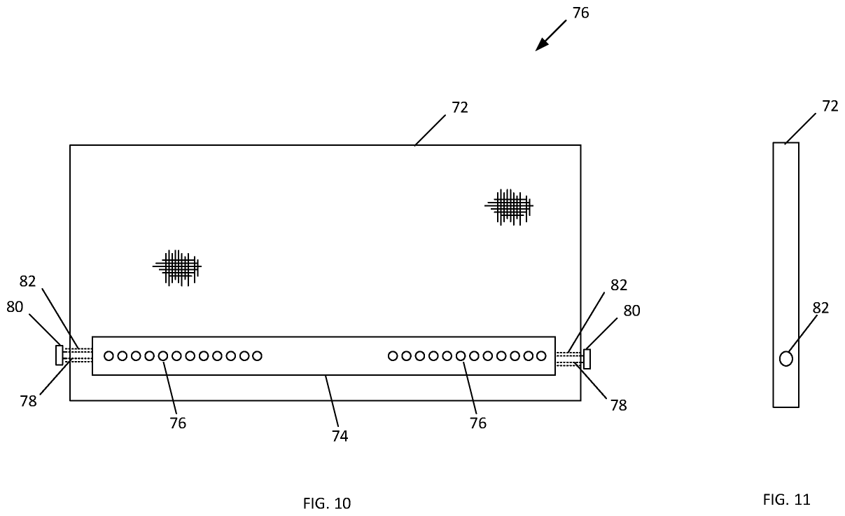

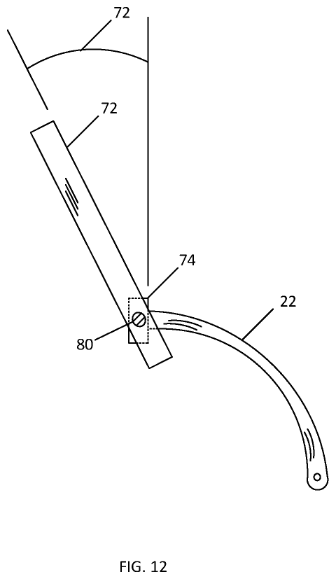

As illustrated in FIGS. 10-12, an embodiment of thermal barrier structure 70 is disclosed. Thermal barrier structure 70 includes a heatshield 72 and a support plate 74 having a plurality of support access openings 76 therein. Further, rotation rods 78 extend horizontally away from support plate 74 and through rotation passages 82 located within heatshield 72. Rotation rods 78 allow for heat shield 72 to rotate relative to support plate 74 providing the user to set a desired angle of heat shield 72 relative to the attached barbecue grill, nearby structural wall or another item.

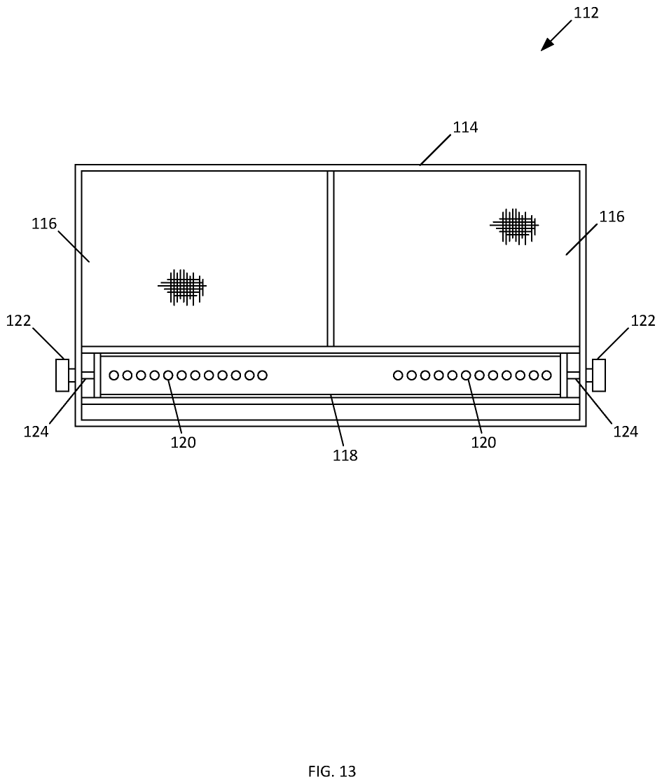

As illustrated in FIG. 13, an additional embodiment of a thermal barrier structure 112 is disclosed. Thermal barrier structure 112 is constructed from heat resistant material which is capable of absorbing heat emitted from a barbecue grill. Thermal barrier structure 112 may include two heatshields 116 and a support plate 118 having a plurality of support access openings 120. Support access openings 20 are configured to receive one end of a support arm. A support frame 114 holds the heatshields 116 and the support plate 118.

Support plate 18 may include a plurality of support access openings 20 running horizontally there along. This will allow for support structure 14 to be configured to be adaptable to a plurality of barbecue grills having different widths. Rotation rods 124 extend horizontally away from support plate 118 and allow for the support frame 114 to rotate relative to support plate 118 providing the user to set a desired angle of the heatshields 116 relative to the attached barbecue grill, nearby structural wall or another item. Tightening knobs 122 lock the support frame 114 at the desired angle.

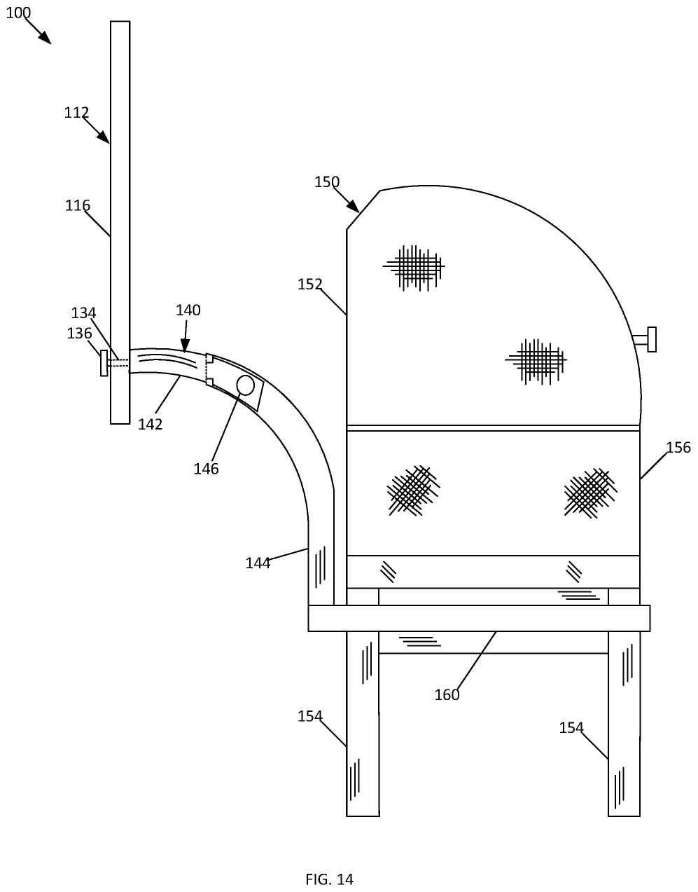

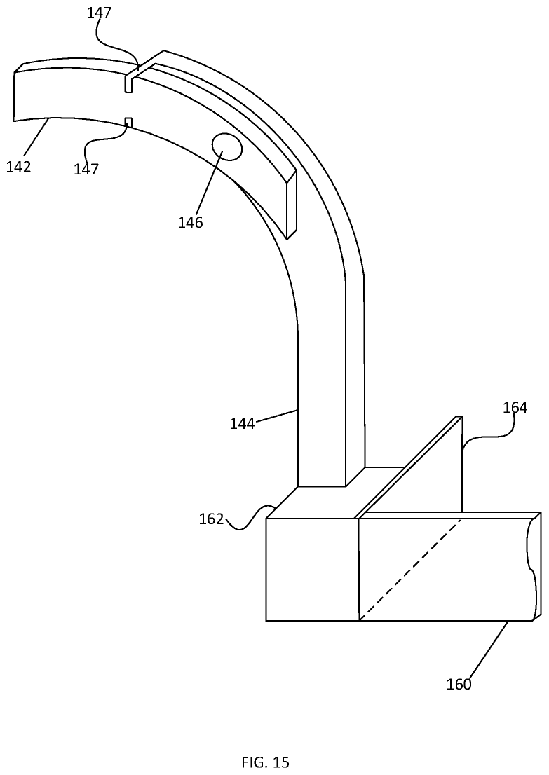

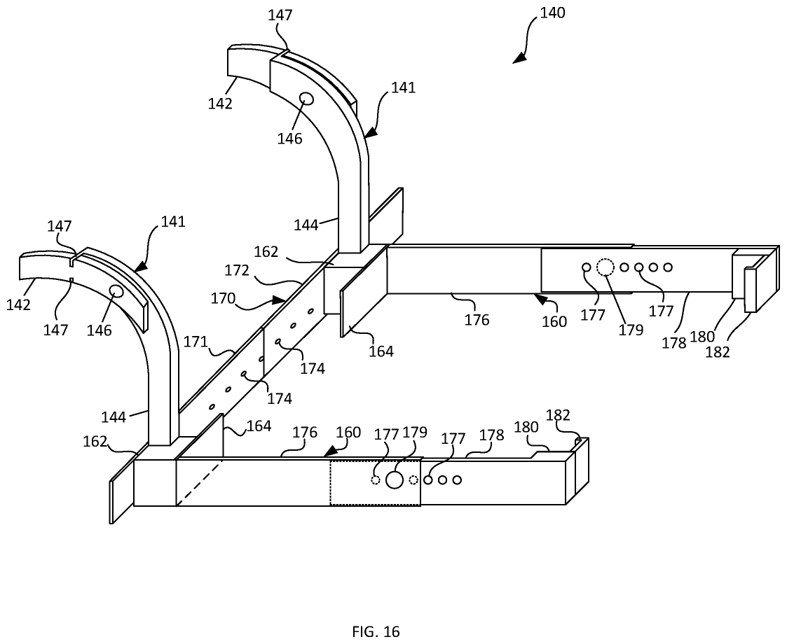

As illustrated in FIGS. 14-16, an additional embodiment of the support structure for 140 is disclosed. In this embodiment, the support structure is generally secured to a barbecue grill 150 having a grill section 156 being supported by a plurality of legs 154 and a lid 152. The support structure 140 is also generally secured to a thermal barrier structure 112 such that the thermal barrier structure 112 is positioned at a distance away from barbecue grill 150 so as not to interfere with the normal course of operation of barbecue grill 150 but close enough to act as a thermal barrier to reduce the amount of heat that is exposed to a wall or other structures located behind the grill.

In this embodiment, support structure for 140 may include two support arms 141, where each support arms 141 are secured to the thermal barrier structure 112 and secured to a support base 162. Each support arm 141 has a lower arm 144 and an upper arm 142. Upper arm 142 is slidably engaged with the lower arm 144 to allow for adjustment to the length of the support arm 141. Upper arm 142 is held close to the lower arm 144 by a retention tab 147 and is locked at the desired location by a support arm securing bolt 146. The inclusion of two support arms 141 is illustrative and not meant to be limiting. Those skilled in the art will recognize that one or more support arms may be used and would be within the scope of the present invention. The inclusion of a securing bolt 146 is illustrative and not meant to be limiting. Those skilled in the art will recognize that any fastener that has the capability of securing the upper arm to the lower arm is within the scope of the present invention.

The lower arm 144 extends from a support base 162 at a lower end and slidably engages the upper arm 142 at an upper end. The upper arm 142, in turn, slidably engages the lower arm 144 at a lower end and is secured to the thermal barrier structure 112 at an upper end.

In this embodiment, the support base 162 includes a grill engagement plate 164 that is configured to engage the back portion of the grill 150. Grill engagement plate 164 may be bolted or otherwise affixed to the grill.

Additional lateral support may be provided by a lateral support bar 170 being secured to the support bases 162 of the two support arms 141. The lateral support bar 170 may include a first lateral support bar 171 and a second lateral support bar 172. The lateral support bars 171, 172 have a plurality of adjustment holes 174 to allow for the second lateral support bar 172 to be slidably engaged with the first lateral support bar 171.

In this embodiment, further support may be provided by a horizontal support bar 160 that extends from the support base 162 toward the from the front side of the grill 150. Horizontal support bar 160 may include a first horizontal support bar 176 and a second horizontal support bar 172. The horizonal support bars have a plurality of adjustment holes 177 to allow for the second horizonal support bar 178 to be slidably engaged with the first horizonal support bar 176. A securing knob 179 may lock the horizonal support bars 176, 177 at the desired length.

In this embodiment, at the distal end of the second horizontal support bar 178 is a grill front engagement portion 180 that includes a locking component 182. Front engagement portion 180 is configured to engage the front portion of the grill 150 either at the front of the leg or at the front of the grill section 156, depending on the design of the grill 150. Locking component 182 may be extendable to allow for adjustments when securing to the front of the grill 150.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A thermal barrier apparatus for use with a barbeque grill, comprising:
a thermal barrier structure constructed from heat resistant material; and
a support structure secured to the thermal barrier structure and the barbeque grill,
wherein the thermal barrier structure is located at a distance sufficiently away from the barbeque grill such that the thermal barrier structure provides a thermal barrier for heat emitted from the barbeque grill while not impairing the operation of the barbeque grill.

2. The thermal barrier apparatus of claim 1, wherein the dimensions of the thermal barrier structure extend at least to the width of the barbeque grill.

3. The thermal barrier apparatus of claim 1, wherein the thermal barrier structure further comprises a rotational mechanism to allow the thermal barrier structure to be rotated.

4. The thermal barrier apparatus of claim 1, wherein the support structure is configured to be adaptable to a plurality of barbeque grills having different widths.

5. The thermal barrier apparatus of claim 1, wherein the support structure comprises
at least two support arms, each support arm secured at a first end to the barbeque grill and secured at a second end to the thermal barrier structure.

6. The thermal barrier apparatus of claim 5, wherein the thermal barrier structure further comprises a support plate having at least two securing openings configured to receive and secure the second end of each support arm thereto.

7. The thermal barrier apparatus of claim 6, wherein the support plate comprises a plurality of securing openings configured to receive and secure the second end of each support arm thereto.

8. The thermal barrier apparatus of claim 6, wherein the support plate further comprises a rotational mechanism to allow the thermal barrier structure to be rotated.

9. A thermal barrier apparatus for use with a barbeque grill, comprising:
a thermal barrier structure constructed from heat resistant material; and
a support structure secured to the thermal barrier structure and the barbeque grill,
the support structure having a support base and at least two support arms, each of the at least two support arms having a lower arm and an upper arm, each lower arm having a lower arm upper end and a lower arm lower end securing to the support base, each upper arm having an upper arm lower end being slidably engaged with the lower arm upper end and an upper arm upper end secured to the thermal barrier structure,
wherein the thermal barrier structure is located at a distance sufficiently away from the barbeque grill such that the thermal barrier structure provides a thermal barrier for heat emitted from the barbeque grill while not impairing the operation of the barbeque grill.

10. The thermal barrier apparatus of claim 9, wherein the support structure further comprises:
at least two lateral support bars secured to two opposing sides of the barbeque grill.

11. The thermal barrier apparatus of claim 10, wherein each of the at least two lateral support bars are extendable.

12. The thermal barrier apparatus of claim 10, wherein each of the at least two lateral support bars further comprises:
a grill front engagement portion configured to engage the front portion of the barbeque grill, the grill front engagement portion having a locking component.
